(19) United States
(12) Patent Application Publication
(10) Pub. No.: US 2009/0118408 A1
(43) Pub. Date: May 7, 2009

(54) Dielectric compositions containing coated filler and methods relating thereto

(76) Inventors: G. Sidney Cox, Durham, NC (US); Thomas Edward Carney, Orient, OH (US); Michele L. Ostraat, Jamison, PA (US); Stephen Mazur, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/982,767

(22) Filed: Nov. 5, 2007

(51) Int. Cl. C08K 3/10; C08K 3/22; C08K 3/36

(52) U.S. Cl. 524/403; 524/408; 524/413; 524/437; 524/442

(57) ABSTRACT

The present disclosure relates to a dielectric composition having a resin and a filler. The filler is used to raise the dielectric and has a passivating surface coating thereon.

### FIELD OF THE DISCLOSURE

The present disclosure relates generally to dielectric compositions having a high dielectric constant (also called “high k”) filler. More specifically, the dielectric compositions of the present invention provide advantageously low leakage current in capacitor type applications, due at least in part to a passivating coating applied to the high k filler.

### BACKGROUND OF THE DISCLOSURE

In the electronics industry there is a need for smaller capacitors without decreasing their performance. Capacitors store electrical energy. One way to achieve smaller capacitors capable of storing the same amount of electrical energy is to add a filler having a high dielectric constant. Typically, using a high dielectric constant filler in the dielectric layer of a capacitor allows for storage of the same amount of electrical charge for a given thickness of the dielectric layer in a reduced capacitor area versus dielectrics containing no filler.

Unwanted leakage current is a common disadvantage of high dielectric constant fillers. Also, as the dielectric film thickness decreases leakage current generally increases.

A need exists for increasing the amount of electrical energy stored in a capacitor without increasing the size of the capacitor, while also reducing the leakage current.

### SUMMARY OF THE INVENTION

The present invention is directed to a dielectric composition having: i. 10 to 65 volume % of filler having at least one passivating surface coating; and ii. 35 to 90 volume % of a resin. The filler can be any dielectric filler, such as, a paraelectric filler, a ferroelectric filler or the like. The passivating surface coating can be an oxide or the like and can generally be present from about 0.1 up to about 20 weight % of the filler. The dielectric composition can be made into the form of a film, a thick film paste, a laminate or the like.

### DETAILED DESCRIPTION OF THE PREFERRED EMBODIMENT(S)

While the present disclosure will now describe the preferred embodiment(s) of the present invention, it is to be understood that the present disclosure is not intended to limit the invention to any disclosed embodiment. On the contrary, the present disclosure is intended to cover all alternatives, modifications and equivalents as may be included in the spirit and scope of the invention as defined by the appended claims.

In one embodiment, the dielectric composition of the present invention comprises: i. 10 to 65 volume % filler comprising at least one passivating surface coating; and ii. 35 to 90 volume % polymeric type resin.

The filler of the present invention can be any insulative type material, which is to say, a material having a resistivity to electron flow of greater than 10, 50, 100, 500, 1000, 5000 or 10,000 ohms. In one embodiment, the filler comprises ceramic particles, platelettes or fibers. Useful ceramic fillers include metal oxides, such as, alumina, silica, titania and the like. In one embodiment, the filler is intended to increase the dielectric property of the final composition.

The term “dielectric constant” is intended to mean the electrostatic energy stored per unit volume for unit potential gradient and is the ratio of the capacitance of a material to the capacitance resulting when the material is replaced by air or vacuum. Capacitance is a measure of the amount of electric charge stored for a given electric potential. The capacitance can be calculated if the geometry of the conductors and the dielectric properties of the dielectric between the conductors are known. Capacitance is proportional the surface area of the conductor and inversely proportional to the distance between the conductors.

In some embodiments, the filler is selected from organic materials, inorganic materials or mixtures thereof. In some embodiments, the filler has a dielectric constant of at least 50. In some embodiments the filler has a dielectric constant of at least 75. In some embodiments the filler has a dielectric constant of at least 150. In some embodiments, the filler is selected from those having a dielectric constant between 50 and 10,000. In some embodiments, the filler is selected from those having a dielectric constant between 50 and 150. In some embodiments the filler has a dielectric constant between 70 and 150. In some embodiments the filler has a dielectric constant between 150 and 10,000. In some embodiments, the filler is selected from those having a dielectric constant between 300 and 10,000. As such, the term “high dielectric constant” is intended to mean a dielectric constant of at least 50.

The filler can be any shape, including regularly or irregularly shaped and may have a smooth or rough surface texture. In some embodiments fillers of different shapes are used. In some embodiments the filler is particulate. In some embodiments, fillers having different textures are used. In some embodiments, the filler particle has portions of the surface that are smooth and other portions that are rough. In some embodiments, the filler has an average size distribution where 50% of the particles are smaller than 1 micron. In some embodiments, the filler has an average size distribution where 50% of the particles are smaller than 0.75 microns. In some embodiments, the filler has an average size distribution where 50% of the particles are smaller than 0.5 microns. In some embodiments, the filler has an average size distribution where 50% of the particles are smaller than 0.4 microns. Particle size distribution measurements were made on a Horiba LA-930 analyzer.

In some embodiments, the filler is present in the amount between and optionally including any two of the following numbers 10, 12, 14, 16, 18, 20, 22, 24, 26, 28, 30, 32, 34, 36, 38, 40, 42, 44, 46, 48, 50 ,52, 54, 56, 58, 60, 62 and 65 volume % of the composition. In some embodiments, the filler is present in the amount from 10 to 65 volume % of the composition. In some embodiments, the filler is present in the amount from 15 to 50 volume % of the composition. In some embodiments, the filler is present in the amount from 20 to 40 volume % of the composition.

In some embodiments, the filler is selected from at least one paraelectric filler, at least one ferroelectric filler or mixtures of two or more such fillers. Useful paraelectric fillers are TiO₂, Ta₂O₅, Hf₂O₅, Nb₂O₅, Al₂O₃, Steatite and mixtures thereof. Useful ferroelectric fillers are BaTiO₃, BaSrTiO₃, PbZrTiO₃, PdLaTiO₃, PdLaTiO₃, PdLaZrTiO₃, PdMgNbO₃, CaCuTiO₃ and mixtures thereof.

Paraelectric fillers are ceramic particles that show a linear response of charge or polarization versus voltage and show a total reversible polarization of charges within the filler structure after the applied electric field is removed. In some embodiments, paraelectric fillers are selected from those having a dielectric constant between 50 and 150. In some embodiments, the paraelectric fillers exhibit high breakdown voltages of approximately 1000 volts per mil or greater and volume resistivities of 10E12 ohm-cm or greater in their bulk form. In some embodiments, the paraelectric fillers show very small changes in dielectric constant with changes in temperature.

Ferroelectric fillers are ceramic particles that show a non-linear response of charge and polarization versus voltage. Traditionally ferroelectric fillers are used to increase the dielectric constant of a dielectric, because they usually have a higher dielectric constant compared to paraelectric fillers. Ferroelectric fillers have a dielectric constant between 150 and 10,000. The higher dielectric constants of ferroelectric materials are caused by the non-linear response of charge and polarization versus voltage. This non-linear response is a key property of ferroelectric materials. Ferroelectric fillers also show a hysteresis affect with polarization by an applied field because of nonreversible changes in the crystal structure. The dielectric constant for ferroelectric fillers can vary greatly with temperature. Ferroelectric fillers have a Curie temperature. The Curie temperature is the temperature at which the ferroelectric filler loses spontaneous polarization and ferroelectric characteristics. Ferroelectric fillers above their Curie temperature behave as paraelectrics. While ferroelectric fillers have higher dielectric constants, ferroelectric materials tend to have higher leakage current than paraelectric materials. Ferroelectric materials also tend to have lower dielectric withstanding voltage and wider variation in capacitance with temperature.

The filler has a passivating surface coating. The term “passivating” herein denotes treating a surface to render the surface less active. A passivating surface coating refers to a material which, when applied to the outer surface of the filler, decreases the leakage current of the dielectric film in a capacitor. The term “capacitor” herein denotes a device whose function is to store electrical energy. It is made of two conductive layers separated by insulating or dielectric material. It blocks the flow of direct current, and allows the flow of alternating current. The term “conductive layers” herein denotes metal layers or metal foils. Conductive layers do not have to be used as elements in pure form; they may also be used as metal foil alloys, such as copper alloys containing nickel, chromium, iron, and other metals.

Leakage current is an undesirable amount of current that flows through an insulator (dielectric) between two electrodes. This undesirable flow of current through an insulator drains charge on capacitor. Normally it is assumed that the dielectric film will prevent the flow of current through a capacitor. Although the resistance of the dielectric film is extremely high, a minute amount of current does flow. Such a small amount of current leaks out that it is generally ignored. However, if the leakage current is abnormally high, there will be a loss of charge and overheating of the capacitor. Leakage current can vary with time, temperature and voltage. Leakage current will also depend on the amount of filler used and the thickness of the dielectric layer. Decreasing the thickness of dielectric layer will increase the leakage current. Leakage current is measured by applying a potential between two electrodes and across the dielectric layer. The current between the two electrodes is measured. The current measured would be the leakage current.

In some embodiments, the passivating surface coating is selected from organic materials, inorganic materials or mixtures thereof. In some embodiments, the passivating surface coating has a dielectric constant less than 50. In some embodiments, the passivating surface coating has a dielectric constant less than 30. In some embodiments, the passivating surface coating has a dielectric constant less than 10. In some embodiments, the passivating surface coating is oxide. The term “oxide” herein denotes a chemical compound containing at least one oxygen atom and other elements but does not contain carbon. In some embodiments, the passivating surface coating is a mixture of at least 2 oxides. In some embodiments the passivating surface coating is an oxide selected from the group consisting of silica, alumina, zirconia and mixtures thereof.

In some embodiments, there is a practical upper limit to the amount of passivating surface coating present. If the amount of passivating surface coating is too thick on the filler, the desired increase in dielectric constant of the dielectric composition will generally not be achieved. In some embodiments, the passivating surface coating is present between and optionally including any two of the following numbers 0.1, 0.5, 1, 3, 5, 7, 9, 11, 13, 15, 17, 19 and 20 weight % of the total weight of the filler. The passivating surface coating is present in an amount from 0.1 to 20 weight % of the total weight of the filler. In some embodiments, the passivating surface coating is present in an amount from 0.5 to 15 weight % of the total weight of the filler. In some embodiments, the passivating surface coating is present in an amount from 1 to 10 weight % of the total weight of the filler. In some embodiments, the passivating surface coating is present in an amount from 3 to 9 weight % of the total weight of the filler. In some embodiments, the passivating surface coating can be a single layer or more than one layer, continuous or non-continuous, on the surface of the filler. In some embodiments, a continuous uniform coating is desired.

In one embodiment, the passivating surface coating may be formed by precipitating the oxide material from any number of solution compositions onto the filler from the solution, hence referred to as “wet treatment”. In some embodiments, it may necessary to control the pH of the solution. In some embodiments the passivating surface coating may be formed by vapor phase deposition. One of skill art would know other ways to form the passivating surface coating on the filler.

In some embodiments, the leakage current at 500 volts DC is between and optionally including any two of the following numbers 0.04, 0.05, 0.06, 0.1, 0.2, 0.3, 0.4, 0.42, 0.5, 0.8, 1.0, 1.5, 2.0, 2.2, 2.4, 3, 6, 10, 20, 30, 40, 50, 60, 70, 80, 90, 94 and 100 microamps/cm². In some embodiments, the leakage current of a capacitor containing the composition of this disclosure is from 0.04 to 94 microamps/cm² at 500 volts DC. In some embodiments, the leakage current of a capacitor containing the dielectric composition of this disclosure is from 0.42 to 50 microamps/cm² at 500 volts DC. In some embodiments, the leakage current of a capacitor containing the dielectric composition of this disclosure is from 2.4 to 32 microamps/cm² at 500 volts DC.

In some embodiments, the leakage current at 250 volts DC is between and including any two of the following numbers 0.001, 0.002, 0.005, 0.01, 0.02, 0.04, 0.05, 0.06, 0.1, 0.15, 0.2, 0.25, 0.3, 0.35, 0.4, 0.42, 0.5, 0.55 and 0.6 microamps/cm². In some embodiments, the leakage current of a capacitor containing the dielectric composition of this disclosure is from 0.001 to 0.6 microamps/cm² at 250 volts DC. In some embodiments, the leakage current of a capacitor containing the dielectric composition of this disclosure is from 0.002 to 0.25 microamps/cm² at 250 volts DC. In some embodiments, the leakage current of a capacitor containing the dielectric composition of this disclosure is from 0.002 to 0.04 microamps/cm² at 250 volts DC.

The resin of the present disclosure refers to a material comprising at least one polymerizable compound, at least one polymer or at least one of each. Polymerizable compound means any compound capable of reacting with itself or another compound to form large molecules comprised of repeating structural units. By structural unit it is meant a relatively simple group of atoms joined by covalent bonds in a specific three dimensional arrangement. In some embodiments, the polymerizable compound can be a monomer or combination of monomers. In some embodiments, the polymerizable compound can be a low molecular weight polymer precursor. For purposes of this disclosure, resin and polymer may be used interchangeably.

In some embodiments, the resin is a copolymer. The term “copolymer” is intended to mean polymer having at least two different repeat units. In some embodiments, the resin is a thermosetting resin. In other embodiments, the resin is thermoplastic. In another embodiment, the resin may be a mixture of thermosetting resins and thermoplastic resins. In some embodiments, the polymerizable compound may be cured or set via heat or other means including but not limited to exposure to radiation (e.g., microwave, ultraviolet, infared). In some embodiments, the resin is a polyamic acid (polyimide precursor).

Useful resins include epoxy, acrylic, polyurethane, polyester, polyesteramide, polyesteramideimide, polyamide, polyamideimide, polyetherimide, polyesterimide, polycarbonate, polysulfone, polyether, polyetherketone, bismaleimide resins, bismaleimide triazines, liquid crystal polymers, cyanate esters, fluoropolymers and mixtures of two or more. The resins are commercially available or can be made by techniques well know in the art.

In some embodiments, the resin is a polyimide. Some examples of dianhydrides useful for producing polyimide resins of the present disclosure include, but are not limited to, 4,4′-oxydiphthalic dianhydride (ODPA), pyromellitic dianhydride (PMDA), 3,4,3′,4′-biphenyltetracarboxylic dianhydride, 3,3′,4,4′-benzophenone tetracarboxylic dianhydride, naphthalene-2,3,6,7-tetracarboxylic dianhydride, naphthalene-1,4,5,8-tetracarboxylic dianhydride, bis(3,4-dicarboxyphenyl) ether dianhydride, bis(3,4-dicarboxyphenyl) sulfone dianhydride, 2,3,2′,3′-benzophenonetetracarboxylic dianhydride, bis(3,4-dicarboxyphenyl) sulfide dianhydride, bis(3,4-dicarboxyphenyl) methane dianhydride, 2,2-bis(3,4-dicarboxyphenyl) propane dianhydride, 2,2-bis(3,4-dicarboxyphenyl) hexafluoropropane, 3,4,3′,4′-biphenyltetracarboxylic dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-1,8,9,10-tetracarboxylic dianhydride, pyrazine-2,3,5,6-tetracarboxylic dianhydride, benzene-1,2,3,4-tetracarboxylic dianhydride, and thiophene-2,3,4,5-tetracarboxylic dianhydride and mixtures thereof.

Some examples of diamines useful for producing polyimide resins of the present disclosure include, but are not limited to, 1,3-bis(4-aminophenoxy) benzene (APB-134), 3,4′-oxydianiline, 4,4′-oxydianiline, meta-phenylenediamine, para-phenylenediamine, 2,2-bis(4-aminophenyl) propane, 4,4′-diaminodiphenylmethane, 4,4′-diaminodiphenyl sulfide, 4,4′-diaminodiphenyl sulfone, 3,3′-diaminodiphenyl sulfone, 4,4′-diaminodiphenyl ether, 2,6-diaminopyridine, bis(3-aminophenyl) diethyl silane, benzidine, 3,3′-dichlorobenzidine, 3,3′-dimethoxybenzidine, 4,4′-diaminobenzophenone, N,N-bis(4-aminophenyl)-n-butylamine, N,N-bis(4-aminophenyl) methylamine, 1 5-diaminonaphthalene, 3,3′-dimethyl-4,4′-diaminobiphenyl, m-aminobenzoyl-p-aminoanilide, 4-aminophenyl-3-aminobenzoate, N,N-bis(4-aminophenyl) aniline, 2,4-bis(beta-amino-t-butyl) toluene, bis(p-beta-amino-t-butylphenyl) ether, p-bis-2-(2-methyl-4-aminopentyl) benzene, p-bis(1,1-dimethyl-5-aminopentyl) benzene, m-xylylenediamine, p-xylylenediamine, hexamethylene diamine, position isomers of the above, and mixtures thereof.

In some embodiments, the resin is present in the amount between and optionally including any two of the following numbers 35, 38, 40, 42, 44, 46, 48, 50 ,52, 54, 56, 58, 60, 62, 64, 66, 68, 70, 72, 74, 76, 78, 80, 82, 84, 86, 88 and 90 volume %. In some embodiments, the resin is present in the amount from 35 to 90 volume % of the dielectric composition. In some embodiments, the resin is present in the amount from 50 to 85 volume % of the dielectric composition. In some embodiments, the resin is present in the amount from 60 to 80 volume % of the dielectric composition.

In some embodiments, the resin, in the absence of filler as described herein, has a dielectric constant from 2 to 6. In some embodiments, the resin, in the absence of filler as described herein, has a dielectric constant from 3 to 5. The increase in the dielectric constant of the dielectric composition, relative to the resin alone, is determined by the volume fraction of filler and the dielectric constant of the filler used. In some embodiments, the increase in dielectric constant of the dielectric composition is from 50 to 90%. In some embodiments, the increase in dielectric constant of the dielectric composition is 60% to 80%. There is a practical upper limit on the amount of filler that can be added to the resin.

At high loadings the physical properties of the dielectric composition may be adversely affected. For example, the dielectric composition will become brittle. This upper limit will be determined by the application in which the composition will be used.

Solvents may be added to the dielectric composition to aid in dispersion of the filler within the resin. The solvent is not important just so long as it is compatible with the polymer and does not detrimentally affect the desired properties of the dielectric composition. Examples of typical solvents include dimethlyacetamide and N-methylpyrrolidone, aliphatic alcohols, such as isopropanol, esters of such alcohols, for example, acetates and propionates; terpenes such as pine oil and alpha- or beta-terpineol, or mixtures thereof; ethylene glycol and esters thereof, such as ethylene glycol monobutyl ether and butyl cellosolve acetate; carbitol esters, such as butyl carbitol, butyl carbitol acetate and carbitol acetate and other appropriate solvents.

The dielectric composition may also include other additives such as dispersion agents, adhesive agents, stabilizers, antioxidants, leveling agents, rheology control agents, flame retardants, plasticizers, lubricants, static control agents, processing aids and any other additive commonly used in the art provided they do not detrimentally affect the desired properties of the dielectric composition.

The dielectric composition can be used in a variety of forms. In some embodiments, the composition is in the form of a film. The term “film” herein denotes a free standing film or a coating on a substrate. The term “film” is used interchangeably with the term “layer” and refers to a covering a desired area. Films and layers can be formed by any conventional deposition technique, vapor deposition, liquid deposition (continuous and discontinuous techniques), and thermal transfer. Continuous deposition techniques, include but are not limited to, spin coating, gravure coating, curtain coating, dip coating, slot-die coating, spray coating, and continuous nozzle coating. Discontinuous deposition techniques include, but are not limited to, ink jet printing, gravure printing, and screen printing. For purposes of the disclosure, useful film thickness is from 2 to 50 microns thick. In some embodiments, the film thickness is from 4 to 35 microns. In another embodiment, the film thickness is from 8 to 25 microns. In other embodiments, the film thickness is from 12 to 15 mils.

In some embodiments, the composition can be in the form of a thick film paste. The term “thick film paste” herein denotes a material that can be pressed through a screen on to a surface to form a layer. The material can be conductive, resistive or dielectric which when heated forms conductors, resistors and capacitors. The material or “paste” is composed of solids suspended in a solvent.

In some embodiments, the composition is in the form of a laminate. The term “laminate” herein denotes a material constructed by uniting two or more layers of material together. The materials can be the same or different. In one embodiment the laminate comprises at least one metal layer and one dielectric layer. In another embodiment, the laminate comprises more than one metal layer and at least one dielectric layer. In another embodiment the laminate comprises more than one metal layer and more than one dielectric layer. In some embodiments, the metal layer is on one side of a dielectric layer. In other embodiments, a metal layer is present on both sides of a dielectric layer. In some embodiments, the metal is present as an electrical conductor. In some embodiments the metal can be gold, titanium, silver, and alloys thereof. In other embodiments, the metal is copper. In some embodiments, the metal layer has a matte surface on one side to facilitate adhesion between the metal and the dielectric layer. In some embodiments, the metal layer has a matte surface on both sides. In some embodiments, the laminates may be stacked and interconnected to give more complex arrangements of layers, where the layers may have different dielectric constants and different thicknesses. In some embodiments, the dielectric layer is thermally bonded to the metal layer. In some embodiments, an adhesive may be used to laminate the metal layer and the dielectric layer. In some embodiments, the metal layer has a thickness from 10 to 40 microns. In some embodiments, the metal layer has a thickness from 18 to 35 microns. In some embodiments, the metal layer has a thickness from 20 to 30 microns.

The laminate can be produced by any of the conventional methods used by one skilled in the art, including, but not limited to:

extrusion or coextrusion of a melt or solution, followed by die casting. The melt or solution can be cast directly onto conductive metal foil. Or the melt or solution can be cast as a free-standing film by casting onto a drum, belt, release film, glass plate, or other suitable substrate and subsequently laminating or bonding to the conductive metal foil;

wet coating methods: Spray coating, spin coating, dip coating, gravure coating, “Doctor Blade”, drawdown rod, wire wound rod, casting knife, air knife, roll, brush, squeeze roll, kiss roll, etc. on to the conductive metal foil;

calendaring, powder coating, electrostatic coating, vapor deposition or sputtering.

casting or coating from solution may use a coagulation or evaporation process to remove the solvent. Some polymers, such as polyamic acids or epoxies, may require curing in order to achieve the final chemistry or to reach a desirable level of physical properties. Curing may be accomplished in sequence with the coating/casting operation, or it may be conducted in a separate step. In the latter case, a so-called “green” or “B-stage” film/coating is initially prepared. Films may be uniaxially or biaxially oriented using conventional methods, such as, but not limited to stretching, blowing, tentering.

In some embodiments, the film can be used as a dielectric layer in a capacitor. Capacitors utilizing a film of the present disclosure are useful for printed wiring boards. A printed wiring board is a structure that provides point-to-point connections, but not printed components, in a predetermined arrangement on a common base. It can be single or double-sided or a multilayer construction of either rigid or flexible composite materials. Other useful application are packages for electronic circuits, leadframe package, a chip on flex package, a lead on chip package, a multi-chip module package, a ball grid array package, chip scale package, a tape automated bonding package, or a build up multilayer package. Multilayer packaging, printed circuit boards, BUM multilayer circuit boards.

The term “package” herein denotes an enclosure for one or more semiconductor chips that allows electrical connection and provides mechanical and environmental protection.

The term “lead on chip package” herein denotes a lead frame designed to align with and connect to the integrated circuit connection pads located on a face of the integrated circuit chip. These connection pads are the points at which all input and output signals, and power and ground connections are made for the integrated circuit to function as designed. The conductors of the lead frame may be any metal suitable for bonding and may be plated, either selectively or non-selectively, as is well-known in the art. Each type of integrated circuit requires a lead frame with a specific pattern of conductors. This pattern may be fabricated using etching or stamping principles well-known in the art of semiconductor materials. In addition to having the correct pattern for a specific integrated circuit, the lead frame must be properly aligned and held in alignment with the integrated circuit connection pads. Once aligned, the lead frame may be connected to the integrated circuit connection pads by wire bonding, tape automated bonding (“TAB”), wedge bonding or other methods well-known in the art.

The term “multi-chip-module package” herein denotes a package containing more than one chip on a substrate. The substrate can be a high-density laminated or built-up printed wiring substrate, silicon, ceramic or metal.

The term “ball grid array package” herein denotes a package in which the external connections to the package are made via a array of ball-type connections, typically solder, all on a common plane.

The term “chip scale package” herein denotes an integrated circuit chip carrier that uses contact pads in place of pins or wires of an overall size 10 to 20% larger than the chip.

The term “tape automated bonding package” herein denotes a process in which precisely etched leads, which are supported on a flexible tape or plastic carrier, are automatically positioned over the bonding pads on a chip. A heated pressure head is then lowered over the assembly, thereby simultaneously thermo-compression-bonding the leads to all the pads on the chip. The chip is then encapsulated (“glob topped”) with epoxy or plastic.

The term “build up multilayer package” herein denotes layers of a printed wiring board that are built up by additions of organic dielectric and patterned copper layers to one or both sides of a PWB laminated core.

The term “lead frame package” refers to a rectangular metal frame with leads. The frame contains the leads, which are connected to semiconductor dies. After encapsulation or lidding of the package, the frame is cut off, leaving the leads extended from the package.

The term “chip on flex package” herein denotes mounting of chips directly on flexible substrates and subsequent wire bonding, automated tape bonding, or flip chip bonding for making electrical interconnects. The chip is then encapsulated (“glob topped”) with epoxy or plastic.

The term “flip chip” herein denotes a semiconductor die having all terminations on one side in the form of solder pads or bump contacts. After the surface of the chip has been passivated, it is flipped over for attachment to a matching substrate.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a”, “an” or “the” are employed to describe elements and components of the invention. This is done merely for convenience and to give a general sense of the invention. This description should be read to include one or at least one and the singular also includes the plural unless it is obvious that it is meant otherwise.

### EXAMPLES

The invention will be further described in the following examples, which do not limit the scope of the invention described in the claims.

Methods for determining dielectric constant are described in ASTM D150, “Standard Test Methods for AC Loss Characteristics and Permittivity (Dielectric Constant) of Solid Electrical Insulation”. Composite film dielectric constant was calculated based the measured capacitance of the 2.5 cm diameter capacitors.

Leakage current is measured with a Hipotronics H300B Series HiPot and Megohmmeter at room temperature. A 250 and 500 volt DC potential is applied between the two copper foil electrodes and across the dielectric layer. At this potential the current between the two electrodes is measured and converted to current per unit area of capacitor electrode.
R-101 Titanium dioxide containing 1.7 wt % alumina on the TiO2 particle surface relative to the total weight of the particle including the coating. Commercially available from DuPont.
R-706 Titanium dioxide containing 2.4 wt % alumina and 3 wt % silica on the TiO2 particle surface relative to the total weight of the particle including the coating. Commercially available from DuPont.
R-960 Titanium dioxide containing 3.3 wt % alumina and 5.5 wt % silica on the TiO2 particle surface relative to the total weight of the particle including the coating. Commercially available from DuPont.
R-350 Titanium dioxide containing 1.7 wt % alumina and 3.0 wt % silica on the TiO2 particle surface relative to the total weight of the particle including the coating. Commercially available from DuPont.
JEC RA roll annealed 35 micron thick copper foil.

The polyamic acid used in the examples is a copolymer of, 4,4′-oxydiphthalic dianhydride (ODPA), pyromellitic dianhydride (PMDA) and 1,3-bis(4-aminophenoxy) benzene (APB-134) having a glass transition temperature of approximately 250° C.

### Example 1

Two slurry batches are prepared. One batch containing R-101 and a second batch containing R-706. The slurries are prepared according to the following recipe, using a Cowles blades disperser in a nitrogen purged mix tank:

| | |
|---|---|
| DMAC (Dimethylacetamide) solvent | 5534 grams |
| TiO2 Filler | 2903 grams |
| 19 wt % polyamic acid solution in DMAC | 635 grams |

DMAC and Tio² are first dispersed for approximately 30 minutes. The polyamic acid solution is then added and dispersed for ˜15 minutes. Slurries are milled in recirculation mode using a Premier model HM1.5 (1.5 liter) media mill (Premier Mill Co., Reading, Pa.), using 0.6-0.8 mm zirconium silicate media. Recirculation rates are 10-20 GPH; tip speed was 2200-2400 FPM. The slurries are milled long enough to ensure >10 batch turnovers, in order to achieve a narrow residence time distribution.

384.3 grams of slurry is mixed with an additional 608.3 grams of the polyamic acid solution. PMDA finishing solution (6 wt % in DMAC) is added incrementally, with stirring, to increase the viscosity of the mixture to 50 PaS.

The finished dispersions are cast by hand onto the treated side of JEC RA copper foil using a stainless steel casting rod. The castings are initially dried at 150° C. to remove most of the solvent, and then cured in a forced air oven at 355° C. The cured coatings are nominally 12 microns thick and contained 51 wt % TiO2 (26 volume %).

The cured titanium dioxide filled films coated on one sheet of copper foil are then laminated to another sheet of copper foil. Each copper sheet is 35 microns thick. The lamination press cycle is started by holding sheets at 250° C. for 1.5 hours under vacuum. A pressure of 0.70 kg/cm²is applied to the sheets for the last ½ hour. The temperature is then raised to 350° C. for an additional 1 hour. After 30 minutes at the higher temperature, the pressure is increased to 24.7 kg/cm². The heat is then turned off and after cooling the samples are removed.

Using dry film photoresist imaging and copper etching, 1 inch diameter capacitors are imaged into one of the copper foils for testing. After electrical testing of the imaged capacitors, the copper foil is removed by etching and the dielectric thickness is measured. The dielectric thicknesses range from 12 to 30 microns thick.

The TiO2 fillers increase the dielectric constant of the composite to around 7 to 8 compared to the dielectric constant of the polymer of 3.4. The composite dielectric constant is the same for both TiO2 types, which is consistent with the dielectric constant of TiO2 particles with rutile crystal structure. Higher loading is clearly possible and would produce even higher composite dielectric constants.

At 15 microns thickness the leakage current for the R-101 is 0.6 and 94.0 microamps/cm² at 250 and 500 volts DC, respectively. At the same thickness the leakage current for the R-706 is 0.05 and 0.42 microamps/cm² at 250 and 500 volts DC, respectively.

### Example 2

Three Slurry batches are prepared. One batch containing R-706, a second batch containing R-960, and a third batch containing R-350. The slurries are prepared according to the following recipe, using a Cowles blades disperser in a nitrogen purged mix tank:

| | |
|---|---|
| DMAC | 443.5 grams |
| TiO2 | 600.0 grams |
| 23 wt % polyamic acid solution in DMAC | 156.5 grams |

The slurries are mixed with a propeller-type agitator in a nitrogen-purged vessel. The polyamic acid solution is first dissolved in DMAC then the TiO2 powder is added and mixed until well-dispersed. The slurries are milled for 30 minutes in recirculation mode in a Netzsch MiniZETA media mill (Netzsch Inc., Exton, Pa.) using 0.8 mm zirconium oxide media, at 2800 RPM shaft speed.

346.0 grams of each slurry is blended with an additional 645.8 grams of polyamic acid solution PMDA finishing solution (6% in DMAC) is added incrementally, with stirring, to increase the viscosity of the mixture to 50 PaS.

The finished dispersions are cast by hand onto the treated side of JEC RA copper foil using a stainless steel casting rod. The castings are initially dried at 150° C. to remove most of the solvent, and then cured in a forced air oven at 355° C. The cured coatings are nominally 12 microns thick and contained 58 wt% TiO2 (31 volume %).

The cured titanium dioxide filled films coated on one sheet of copper foil is then laminated to another sheet of copper foil. Each copper sheet is 35 microns thick. The lamination press cycle started by holding sheets at 250° C. for 1.5 hours under vacuum. A pressure of 0.70 kg/cm² is applied to the sheets for the last ½ hour. The temperature is then raised to 350° C. for an additional 1 hour. After 30 minutes at the higher temperature, the pressure is increased to 24.7 kg/cm². The heat is then turned off and after cooling the samples are removed.

Using dry film photoresist imaging and copper etching, 1 inch diameter capacitors are imaged into one of the copper foils for testing. After electrical testing of the imaged capacitors, the copper foil is removed by etching and the dielectric thickness is measured. The dielectric thicknesses range from 7 to 29 microns thick.

The TiO2 fillers increase the dielectric constant of the composite to 9 compared to the dielectric constant of the polymer of 3.4. The composite dielectric constants are the same for all TiO2 types based on the wt % TiO2 in each type. The composite dielectric constants are consistent with the dielectric constant of TiO2 particles with rutile crystal structure. Higher loading is possible and would produce even higher composite dielectric constants.

At 12 microns thickness, the leakage current for the R-960, R-706, and R-350 is 0.04, 2.4, and 32 microamps/cm² at 500 volts DC, respectively. At 250 volts the leakage current was 0.002, 0.02, and 0.04 microamps/cm², respectively. Extrapolation from example 1, suggests that the leakage current for the R101 TiO2 would have been greater than 2 and 200 microamps/cm² at the 58 wt % loading and 12 microns thick. The examples show that as the weight percent of the passivating surface coating increases, the leakage current decreases.

Note that not all of the activities described above in the general description or the examples are required, that a portion of a specific activity may not be required, and that further activities may be performed in addition to those described. Still further, the order in which each of the activities are listed are not necessarily the order in which they are performed. After reading this specification, skilled artisans will be capable of determining what activities can be used for their specific needs or desires.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense and all such modifications are intended to be included within the scope of the invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

When an amount, concentration, or other value or parameter is given as either a range, preferred range or a list of upper values and lower values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

1. A dielectric composition consisting essentially of:
A. 10 to 65 volume % of filler selected from a group consisting of: paraelectric filler, ferroelectric filler and mixtures thereof, the filler comprising at least one passivating surface coating, wherein the passivating surface coating is an oxide selected from the group consisting of silica, alumina, zirconia and mixtures thereof, and the passivating coating is present from 0.1 up to 20 weight % of the filler;
B. 35 to 90 volume % of a resin selected from the group consisting of epoxy, acrylic, polyurethane, polyimide, polyester, polyesteramide, polyesteramideimide, polyamide, polyamideimide, polyesterimide, polyetherimide, polycarbonate, polysulfone, polyether, polyetherketone, bismaleimide resins, bismaleimide triazines, liquid crystal polymers, cyanate esters, fluoropolymers and mixtures thereof.

2. (canceled)

3. The dielectric composition according to claim 1, wherein the paraelectric filler is selected from the group consisting of TiO₂, Ta₂O₅, Hf₂O₅, Nb₂O₅, Al₂O₃, steatite and mixtures thereof, and wherein the ferroelectric filler is selected from the group consisting of BaTiO₃, BaSrTiO₃, PbZrTiO₃, PdLaTiO₃, PdLaTiO₃, PdLaZrTiO₃, PdMgNbO₃, CaCuTiO₃ and mixtures thereof.

4. (canceled)

5. (canceled)

6. (canceled)

7. (canceled)

8. (canceled)

9. The dielectric composition according to claim 1, in the form of a film.

10. The dielectric composition according to claim 1, in the form of a thick film paste.

11. The dielectric composition according to claim 1, in the form of a laminate.

12. A capacitor comprising the dielectric composition of claim 1, wherein leakage current is less than 0.5 microamps/cm² at 100 to 500 VDC.

13. A capacitor comprising the dielectric composition of claim 1, wherein leakage current is less than 0.2 microamps/cm² at 100 to 500 VDC.

14. A printed wiring board comprising capacitors of claim 12.

15. The laminate according to claim 11 wherein the laminate is used for packaging electronic circuits, said packaging being selected from the group consisting of: a leadframe package, a chip on flex package, a lead on chip package, a multi-chip module package, a ball grid array package, chip scale package, a tape automated bonding package, and a build up multilayer package.
